(19) United States
(12) Patent Application Publication
(10) Pub. No.: US 2018/0268975 A1
(43) Pub. Date: Sep. 20, 2018

(54) Electric Coil System For Inductive-Resistive Current Limitation

(71) Applicant: Siemens Aktiengesellschaft, Muenchen (DE)

(72) Inventors: Anne Bauer, Fuerth (DE); Peter Kummeth, Herzogenaurach (DE); Christian Schacherer, Hallerndorf (DE)

(73) Assignee: Siemens Aktiengesellschaft, Muenchen (DE)

(21) Appl. No.: 15/548,252

(22) PCT Filed: Feb. 26, 2016
(86) PCT No.: PCT/EP2016/054130

§ 371 Date: Aug. 2, 2017

(30) Foreign Application Priority Data
Feb. 27, 2015 (DE) 10 2015 203 533.6
Jun. 11, 2015 (DE) 10 2015 210 655.1

(51) Int. Cl. H01F 6/06; H01F 41/04

(52) U.S. Cl. CPC H01F 6/06; H01F 41/048

(57) ABSTRACT

The present disclosure relates to electric coil systems having a choking coil for inductive-resistive current limitation. The teachings herein may be embodied in an inductive-resistive current limitation system and to a method of production with such an electric coil system. For example, an electric coil system may include: a choking coil; a bearing body arranged inside the choking coil; and at least one closed annular superconducting conductor element having at least one closed annular superconducting layer arranged on the bearing body.

### CROSS-REFERENCE TO RELATED APPLICATIONS

This application is a U.S. National Stage Application of International Application No. PCT/EP2016/054130 filed Feb. 26, 2016, which designates the United States of America, and claims priority to DE Application No. 10 2015 203 533.6 filed Feb. 27, 2015 and DE Application No. 10 2015 210 655.1 filed Jun. 11, 2015, the contents of which are hereby incorporated by reference in their entirety.

### TECHNICAL FIELD

The present disclosure relates to electric coil systems having a choking coil for inductive-resistive current limitation. The teachings herein may be embodied in an inductive-resistive current limitation system and to a method of production with such an electric coil system.

### BACKGROUND

Choking coils are inductive AC resistances used to limit short-circuit currents and reduce high-frequency current components on electrical conductors. They generally have a low DC resistance, such that as a result DC losses can be kept low. In AC networks, choking coils can also be connected in series with a consumer, tp act as a series resistor, thereby reducing the AC voltage present on the consumer.

In medium-voltage AC networks, choking coils with windings of normally-conducting materials, such as copper or aluminum, are used for current limitation or smoothing of current characteristics. The use of such choking coils reduces network stability which, in the light of changing energy policy, specifically in the case of the injection of electrical energy by a multitude of decentralized electricity supply sources, is an increasingly significant factor. To improve the stability of AC electrical networks, it is particularly desirable that, in normal duty, the inductance of the choking coil is low, but is nevertheless able to rapidly assume a high value in the event of a malfunction or in the event of current limitation.

One option for the provision of a choking coil with a highly variable inductance is provided by the concept of a “ground-fault neutralizer”. In known ground-fault neutralizers, a movable iron-containing core, or “plunger core”, is inserted into the center of the coil or removed therefrom. In this manner, the inductance of the choke can be varied. The mechanical movement associated with this variant requires, firstly, an active control facility, and secondly a relatively long time scale of variation, and is thus impractical for state-related short-circuit current limitation. Even with the plunger core in the extracted state, the interior of the choking coil is not free of magnetic fields. Thus, even in this state, the inductance and consequently the impedance of the choking coil are greater than in a coil with an interior which is substantially free of magnetic fields.

DE 10 2010 007 087 A1 describes a current-limiting device having a variable coil impedance. In the current limiter described therein, by the use of a superconducting coil in the interior of a choking coil, the inductance, and thus the impedance of the choking coil, is significantly reduced. This is achieved by means of currents, which are induced in the superconducting coil and, in normal duty, compensate the magnetic field of the choking coil. Upon the overshoot of a specific current value, the superconductor switches to a normally-conducting state and the inductance increases, thereby limiting the current. Upon the switch-out of the excessively high current, the superconductor independently reverts back to the superconducting state within a short time interval, and normal duty can be resumed.

The choking coil with a superconducting screening coil requires relatively complex production of the windings for the inner superconducting coil. Specifically, individual windings, a plurality of windings or the entire inner coil must be short-circuited, to permit the flux of closed ring currents. To this end, normally-conducting electrical connections of optimum conductivity are configured between the tail ends of commercially available superconducting strip conductors, for example by soldering contacts. In a layered arrangement of superconducting strips, current bonding may be achieved by the provision of layers of good conductivity in the bonding region.

Specifically, in strip conductors with high-resistance layers on one side, it can be appropriate to connect a short additional piece of strip conductor to the ends of the ring, such that the current path is routed through layers of good conductivity, in the manner of a “flip contact”. The resulting connection resistance, however, also generates electrical losses associated with the current flux induced in the inner coil which, in turn, also results in a high degree of complexity in the cooling of the superconducting coil. The subsequent connection of the coil windings requires complex production of contact points and is susceptible to failure.

### SUMMARY

The teachings of the present disclosure may be embodied in an electric coil system for inductive-resistive current limitation which reduces the aforementioned disadvantages. Specifically, the system may provide a rapid and reliable variation in the inductance of the choking coil, with low electrical losses in normal duty and simplified production.

For example, a electric coil system (1) may include: a choking coil (3), and a bearing body (5) arranged inside the choking coil (3). In addition, the system may include on the bearing body (5), at least one closed annular superconducting conductor element (7) arranged on the bearing body, and having at least one closed annular superconducting layer (9).

In some embodiments, the choking coil (3) and the bearing body (5) with the at least one superconducting conductor element (7) have a common central axis (A).

In some embodiments, the bearing body (5) comprises at least one cylindrical surface (5a, 5b), upon which the at least one closed annular superconducting layer (9) is arranged.

In some embodiments, the bearing body (5) is configured as a hollow body.

In some embodiments, the at least one closed annular superconducting layer (9) is arranged on an inner surface (5a) of the hollow body.

In some embodiments, the bearing body (5) is configured as a solid body.

In some embodiments, the at least one closed annular superconducting layer (9) is arranged on an outer surface (5b) of the bearing body (5).

In some embodiments, the at least one closed annular superconducting layer (9) comprises a high-temperature superconducting material.

In some embodiments, a plurality of closed annular superconducting conductor elements (7′) which run in a mutually parallel manner, each comprising at least one closed annular superconducting layer (9′), are arranged on the bearing body (5).

In some embodiments, there is a cooling system (11) which comprises a cryostat (13). In some embodiments, the at least one closed annular superconducting layer (9) is arranged on one wall (15) of the cryostat (13).

As another example, an inductive-resistive current limitation system (17) may have an electric coil system (1) as described above.

As another example, a method for producing an electric coil system (1) as described above may include precipitating a closed annular superconducting layer (9) on a surface (5a, 5b) of the bearing body (5).

In some embodiments, the closed annular superconducting layer (9) is precipitated by aerosol deposition.

In some embodiments, the closed annular superconducting layer (9) is precipitated from a solution.

### BRIEF DESCRIPTION OF THE DRAWINGS

The teachings of the present disclosure are described hereinafter with respect to several exemplary embodiments, with reference to the attached drawings, wherein:

FIG. 1 shows a schematic perspective sectional representation of a coil system according to the prior art,

FIG. 2 shows a schematic perspective sectional representation of a coil system according to a first exemplary embodiment,

FIG. 3 shows a schematic perspective view of a bearing body according to a second exemplary embodiment,

FIG. 4 shows a schematic cross section of a coil system according to a third exemplary embodiment,

FIG. 5 shows a schematic cross section of a coil system according to a fourth exemplary embodiment,

FIG. 6 shows a schematic cross section of a coil system according to a fifth exemplary embodiment.

### DETAILED DESCRIPTION

The teachings of the present disclosure may be embodied in a coil system with a choking coil and a bearing body arranged inside the choking coil. On the bearing body, at least one closed annular conductor element, and having at least one closed annular superconducting layer, is arranged. A closed annular superconducting layer is to be understood herein as a continuous superconducting layer, which is self-closed in an annular arrangement by a uniform superconducting material. Accordingly, no additional electrical contacts are to be present, by means of which the superconducting material is electrically connected, for example by normally-conducting materials.

Instead, an annular superconducting conductor loop is formed by the precipitation of the superconducting layer. In the at least one annular and, via this ring, continuous superconducting conductor thus formed, ring currents can thus, by the varying magnetic field of the choking coil, be induced on the interior thereof which, in turn, compensate the magnetic field of the choking coil. In this manner, the region on the interior of the at least one annular conductor element is essentially field-free, thereby significantly reducing the inductance, and thus also the impedance of the choking coil, in comparison with an arrangement which is not field-compensated in this manner. An inductive-resistive current-limiting system having such a coil system can thus be operated with losses which are lower than those which would occur in the absence of such compensation.

The coil system is appropriately designed such that, in the event of a malfunction, e.g. in the presence of currents in the choking coil which exceed a predetermined threshold value, the currents induced in the closed annular superconducting layer rise to the extent that the critical current density is exceeded and the superconduction in said layer breaks down. The inductance of the choking coil thus rises in response to the absence of magnetic field compensation in the interior thereof, and the fault current flowing in an external circuit, in which the choking current is incorporated, can be effectively limited. This limitation proceeds very rapidly, and with no additional control function of the type required for the insertion of a plunger core into the coil.

In comparison with known coil systems having superconducting ring conductors formed of superconducting strip conductors which are subsequently electrically bonded, the coil system, due to the absence of subsequently-incorporated contacts, specifically ohmic contacts, additional resistances in the annular conductor elements can be avoided. Instead, the ring current flows in a continuous superconducting layer, thus reducing the generation of heat in said superconducting layer. As the at least one superconducting conductor element needs to be cooled to a temperature below its critical temperature for the operation of the coil system, a cooling system is appropriately provided in the region of said conductor elements. The smaller the electrical losses in the annular conductor elements, the lower the requisite cooling capacity of this cooling system. In a continuous superconducting annular layer, such losses are reduced.

The production of the at least one annular conductor element may be more straightforward than known systems. In comparison with the production of such a conductor element by the subsequent bonding of the end regions of a strip conductor, fewer process steps are required. Moreover, the likewise complex winding process for such a strip conductor can also be omitted. The requirement for winding machines, winding devices and support structures for the winding, together with soldering devices for the strip conductor, no longer applies, and only one device is required for the application of the coating to the bearing body. As a result, both the complexity of the production process and production costs can be reduced.

Finally, the teachings herein provide a greater fault tolerance of the continuous superconducting layer which, for example, is directly precipitated on the bearing body. In comparison with a winding comprised of narrow strip conductors, minor defects in the form of non-superconducting regions can be tolerated more easily, because the closed annular superconducting layer can be configured to be wider than a closed annular winding, which is typically formed of strip conductors of only a few mm width. In the region of subsequently-formed electrical contacts, the superconducting properties of such conventional strip conductors can be slightly impaired, thereby resulting in additional electrical and thermal losses.

In some embodiments, the inductive current limitation system may include an electric coil system as described above. In addition to the characteristics described, such a current limitation system has electrical contacts for the incorporation of the choking coil in an external circuit. This external circuit can, for example, be an AC power network, specifically a medium-voltage AC network. The advantages of inductive current limitation of this type, in comparison with known systems, proceed in an analogous manner to the described advantages of the coil system.

In some embodiments, the a method for producing an electric coil system includes precipitating a closed annular superconducting layer on a surface of the bearing body. The production method can comprise a plurality of further steps including, for example, the production of the choking coil and the insertion of the bearing body thus coated into an interior of the choking coil. The production of a closed, annular and continuous superconducting layer, specifically in a coating step, and without the subsequent application of electrical contacts, may be used to produce the at least one closed annular conductor element.

The choking coil and the bearing body with the at least one superconducting conductor element can have a common central axis. In other words, the choking coil and the bearing body can be configured in a mutually coaxial arrangement, wherein the bearing body is positioned coaxially on the interior of the choking coil. A coaxial arrangement of this type may provide extensive compensation of the overall magnetic field present in the interior of the entire arrangement, specifically in the interior of the at least one annular conductor element. The central axis herein can appropriately be an axis of symmetry of the choking coil and/or of the bearing body. Although, for example, the choking coil and/or bearing body can be rotationally symmetrical, a lower order of symmetry is also possible, for example a two-fold or multiple rotational symmetry. In some embodiments, the choking coil and bearing body have the same symmetrical properties.

The bearing body can comprise at least one cylindrical surface, upon which the at least one closed annular superconducting layer is arranged. The superconducting layer itself can thus also have the shape of a cylindrical shell surface. This shell surface can either be defined by a single superconducting layer, or a plurality of such closed annular layers can also be arranged on a common cylindrical shell surface.

The aforementioned shell surface can be the shell surface of a straight cylinder. According to the general geometrical definition, a straight cylinder is to be understood here as a body which is obtained by the displacement of a planar base surface along a straight line which is perpendicular thereto. This shape is thus not restricted to cylinders with a circular base surface. Alternatively, for example, oval, egg-shaped or rectangular base surfaces can also be provided. Polygons other than rectangular polygons can also be employed for the definition of the base surfaces, wherein the corners of the polygons can be either acute or rounded.

In some embodiments, the layer geometry can also be dictated by other shell surfaces. For example, the coated surface of the bearing body can also be configured as a concavely and/or convexly curved surface. In some embodiments, a curved shell surface of this type can also show a symmetrical configuration with respect to a central axis. The bearing body can also have a trapezoidal cross section.

In some embodiments, the bearing body can be configured as a hollow body, for example as a hollow cylinder. Such embodiments may reduce consumption of material. On the interior of the hollow body, in the normal operating state, the shielding provides an essentially field-free space, in which further electromagnetically-active materials are not necessarily required. The coil system can thus be configured in the interior of the bearing body with a coreless design. Optionally, however, further components can also be arranged on the interior of such a hollow body, for example an additional soft magnetic core, which can either be configured as a stationary core or as a plunger core.

In some embodiments, the at least one closed annular superconducting layer can then be arranged on an inner surface of the bearing body which is configured as a hollow body. If the bearing body simultaneously functions as an element of a coolant receptacle, as a partition of a cryostat or, in general, as an element of a cooling system and/or thermal insulation for the region of the superconducting layer which is to be cooled. Where the superconducting layer is arranged on the inner shell of a hollow body, the bearing body may be essentially formed of non-electrically-conductive materials such as, for example, plastic, ceramic materials, glass fiber-reinforced plastic, carbon fiber-reinforced plastic, laminated fabric, or laminated paper. If a bearing body of a primarily conductive material is employed, a continuous non-conducting region, at least in the longitudinal direction, may prevent induced eddy currents in the bearing body. In a configuration with a bearing body that encloses the superconducting layer, non-electrically-conductive materials may prevent the induction of currents by the magnetic field of the choking coil. Additional electrical and thermal losses can thus be kept low. Moreover, the influence of undesirably induced currents upon the variation of the impedance is reduced.

In some embodiments, a bearing body configured as a hollow body, alternatively or additionally, can also be provided, on its outer shell surface, with the at least one closed annular superconducting layer. In an embodiment of this type, the bearing body can be formed of electrically-conductive and/or non-electrically-conductive materials, as the latter is arranged in the region which is electromagnetically shielded by the superconducting layer, and the generation of induced currents in the bearing body may be prevented by this shielding. The bearing body may comprise non-conductive materials, as the induced current shielding effect is to be reduced during short-circuit current limitation. For example, the bearing body can also be formed of the aforementioned non-conductive materials and/or of metallic materials including, for example, steel, special steel, or alloys such as Hastelloy or nickel-tungsten alloys. Here again, the bearing body can function as an element of a coolant receptacle, as a partition of a cryostat or, in general, as an element of a cooling system and/or thermal insulation for the region of the superconducting layer which is to be cooled.

In some embodiments, the bearing body may comprise a solid body, wherein the outer surface is provided with the at least one closed annular superconducting layer. For example, a solid cylinder can be employed herein. The materials for a solid body can be selected in a similarly unrestricted manner as in the case of an externally-coated hollow body, and can thus be selected, for example, from the list of materials specified in the preceding paragraph.

In some embodiments, the at least one closed annular superconducting layer can comprise a high-temperature superconducting material. High-temperature superconductors (HTS) are superconducting materials with a critical temperature in excess of 25 K and, in the case of some material classes, for example cuprate superconductors, in excess of 77 K, in which the service temperature can be achieved by cooling with cryogenic materials other than liquid helium. HTS materials are therefore also particularly attractive, as these materials, depending upon the service temperature selected, can exhibit high supercritical magnetic fields and high critical current densities. The high-temperature superconducting layer can comprise, for example, magnesium diboride or a ceramic oxide superconductor, for example a compound of the REBa₂Cu₃Oₓ type (REBCO for short), where “RE” stands for a rare earth element or a mixture of such elements. For the precipitation of layers comprising REBCO compounds, metallic bearing bodies are particularly suitable on the grounds that, for the achievement of high-quality superconducting layers, a pre-structured substrate surface is advantageous, which may also be provided, where applicable, with one or more intermediate layers, configured as a seeding substrate. As an alternative to the materials specified, however, metallic superconductors can also be employed in the annular conductor element.

In some embodiments, a plurality of closed annular superconducting conductor elements may run in a mutually parallel manner, each comprising at least one closed annular superconducting layer, and be arranged on the bearing body. In other words, a plurality of such conductor elements can be configured in an axially displaced arrangement on the bearing body, wherein each conductor element constitutes a self-contained and continuous superconducting conductor loop, with no ohmic contacts. The individual annular conductor elements, for example, can be mutually electrically insulated, but can also be electrically bonded. They can be interconnected, for example, by means of an electrically-conductive bearing body in a normally-conducting arrangement, or the various mutually axially displaced part-rings can be interconnected by means of superconducting bridges. The various part-rings, together with such bridges, where applicable, may have been precipitated onto the bearing body in a common coating step.

Regardless of whether only a single annular conductor element, or a plurality of such conductor elements are present, each of these conductor elements can have an axial dimension of at least 1 mm, e.g., at least 20 mm. The width of the conductor elements (measured perpendicularly to the annular plane thereof) can thus be significantly greater than that which can be achieved, for example, by an annular short-circuiting of commercially obtainable superconducting strip conductors.

The coated shell surface of the bearing body, in addition to the annular conductor elements, can also incorporate uncoated subregions. This arrangement can apply in embodiments with only a single conductor element, and specifically in embodiments incorporating a plurality of adjacently arranged part-rings.

In some embodiments, the at least one annular conductor element can also have a superconducting layer in a varying layer configuration, for example, in order to adapt the thickness or width of the layer to the anticipated magnetic field distribution.

In some embodiments, the electric coil system can incorporate a cooling system for the cooling of the at least one superconducting layer, which comprises a cryostat. By means of this cooling system, the superconducting layer can thus be cooled to a service temperature which is lower than the critical temperature of the superconducting material. By thermal insulation of the superconducting layer from a warm external environment, it can be achieved that, by means of the cooling system, a cryogenic temperature of this type can be maintained continuously. If the winding of the choking coil is constituted of a normally-conducting conductor, the choking coil can be arranged outside the cryostat. Alternatively, it is also possible for the winding of the choking coil to likewise be arranged inside the cryostat, specifically if the winding of the choking coil is also a superconducting winding.

In embodiments in which, other than the at least one annular conductor element, no further electrical components need to be arranged on the interior of the cryostat, the cryostat can be configured with no electrical bushings. It can thus be configured as a substantially closed vessel, with exceptionally low thermal losses, as no electrical bonding with an external circuit is required for the shielding effect of the closed annular conductor element.

In some embodiments, the closed annular superconducting layer can be arranged on one wall of the cryostat. In other words, the bearing body which bears the superconducting layer may constitute one of the limiting walls of the cryostat. A limiting wall of this type can be thermally insulated from a warm surrounding environment, for example by means of vacuum insulation and/or by means of super-insulating layers.

In some embodiments, a method for producing the electric coil system may include precipitating the closed annular superconducting layer by aerosol deposition. In the present context, an aerosol deposition is to be understood as the precipitation of a layer from an aerosol, from a dispersion of solid particles in a gas. To this end, specifically, a source material for the superconducting layer can comprise a powder which is dispersed in a gas. A layer of this type, precipitated from a powder aerosol, on the grounds of the granular structure of the source powder, is easily distinguished from layers produced by other previously-known coating methods such as, for example, physical or chemical gas-phase precipitation. By the aerosol deposition method, superconducting layers can be precipitated far more simply than by conventional methods on non-planar surfaces, such as the shell surface of the bearing body considered in the present case.

The superconducting layer may comprise magnesium diboride. In some embodiments, magnesium diboride can be the primary constituent of this superconducting layer, or the latter can even be essentially comprised of magnesium diboride. The precipitation of a magnesium diboride layer from a powder aerosol can be achieved particularly effectively, as described, for example, in DE 10 2010 031741 B4. The powder dispersed in the aerosol, which is employed as a source material, can either already be present in the form of magnesium diboride, or in the form of a powdered mixture of elementary magnesium and boron, or in the form of a mixture of all three constituents: magnesium diboride, magnesium and boron.

In some embodiments, using aerosol deposition, superconducting magnesium diboride can be formed in defined layers, for example of thickness 1 μm to 100 μm. A magnesium diboride layer precipitated by aerosol deposition can also be applied to non-planar substrates by the emulation of the surface structure thereof, in the form of a continuous coating. In contrast to gas-phase precipitation methods (including, for example, chemical gas-phase precipitation, sputtering or vaporization), by means of aerosol deposition, substantially thicker superconducting layers can be precipitated in a simple manner. In some embodiments, the layer thickness of the superconducting layer is at least 0.5 μm herein, e.g., as much as at least 5 μm.

Magnesium diboride has a critical temperature of approximately 39 K, and thus qualifies as a high-temperature superconductor, although this critical temperature, in comparison with other HTS materials, is somewhat low. The advantages of this material in comparison with ceramic oxide high-temperature superconductors are associated with its ease of production, thereby permitting the exceptionally flexible selection of substrate materials and substrate geometries.

In some embodiments, the superconducting layer can comprise a ceramic oxide high-temperature superconductor. Specifically, this can be a material of the REBa₂Cu₃Oₓ type. This material class permits the development of electrical conductors with higher service temperatures than in the case, for example, of magnesium diboride. In some embodiments, the closed annular superconducting layer can be precipitated from a solution. Specifically, this can permit the precipitation of thicker ceramic oxide superconducting layers.

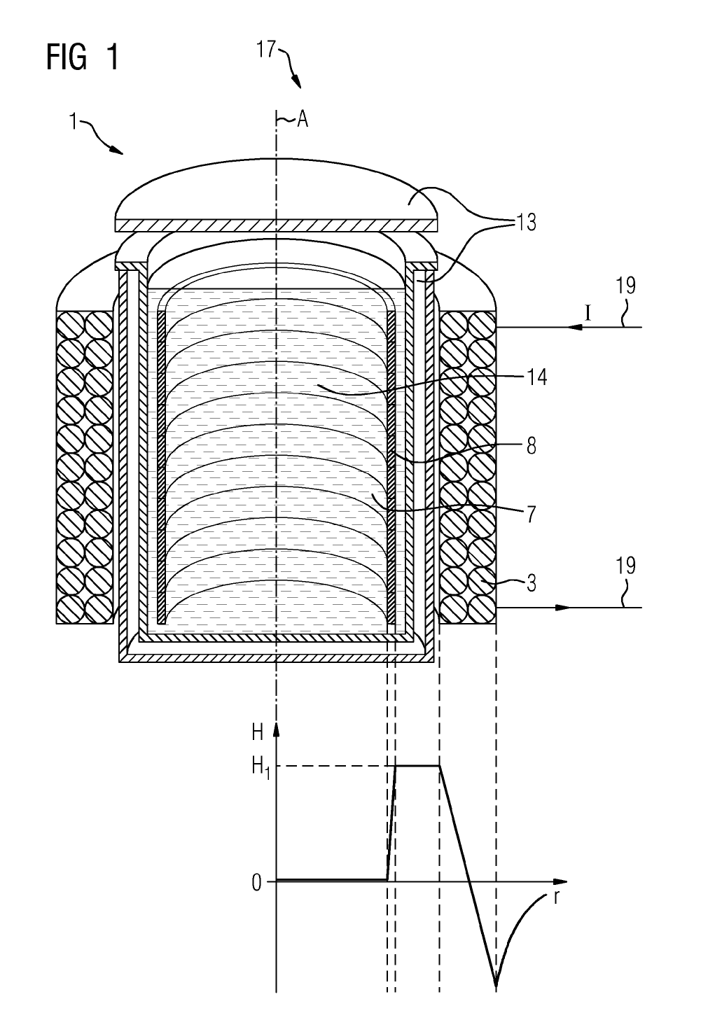

FIG. 1 shows a schematic perspective representation of a coil system according to the prior art, in half-section through the center of the coil system 1. A choking coil 3 arranged on the outer circumference thereof is represented, which radially encloses the other components of the coil system 1 illustrated. The function of this choking coil 3 is the limitation of a short-circuit current and the smoothing of the current characteristic in a higher-level power circuit.

To this end, the choking coil 3, by means of two terminals 19, is connected to the power circuit, which is not represented in greater detail here, in which the current I flows. Although this power circuit can be, for example, a medium-voltage AC network, the choking coil 3 can also be configured with a general design for other industrial or local networks. The choking coil 3 can be rated, for example, for low-voltage networks at AC voltages between 100 V and 1,000 V or, alternatively, for medium-voltage networks at voltages between 1 kV and 52 kV, or for high-voltage networks at voltages in excess of 52 kV. The choking coil can be specifically rated for a power range of at least 250 kVA, at least 400 kVA, or at least 630 kVA.

In the interior of the choking coil 3, a cryostat 13 is arranged which, in the present example, is configured as a bath cryostat and contains a coolant 14. Within the cryostat, an arrangement of a plurality of superconducting conductor elements 7 is arranged, wherein each of these conductor elements 7 is configured as a short-circuited ring of a superconducting strip conductor material 8. By means of the magnetic field generated by the choking coil, a ring current is induced in the annular conductor elements 7. As a result of the superconducting properties of the strip conductor 8, this ring current flows in a virtually loss-free manner. By means of the coolant 14 within the cryostat 13, the superconducting conductor elements 7 are cooled to a service temperature which lies below its critical temperature. The induced ring currents execute a shielding effect of the magnetic field of the choking coil 3 in the further interior region of the coil system 1. This effect is schematically represented in the diagram shown at the bottom of FIG. 1. This diagram shows the characteristic of the magnetic field strength H as a function of the radial position r. At large values of the radius r, which lie substantially outside the choking coil 3, the magnetic field strength is virtually zero. In the radially outer region of the choking coil, the field strength is quantitatively high, and then undergoes a zero-crossing on the interior of the choking coil before rising again, toward the radially inner region of the choking coil, to its maximum value of H₁.

As a result of the non-electrically-conductive design of the cryostat walls, in the present example, the magnetic field strength on the interior of the choking coil initially remains relatively constant at the value of H₁, before falling back down to a value close to zero as a result of the shielding action of the closed annular conductor elements 7. The magnetic field is thus compensated in a radially inner region of the coil system 1. Accordingly, the inductance of the choking coil 3, and thus the impedance of the entire coil system 1 in the higher-level power circuit is significantly reduced, thereby keeping the electrical losses low. To form closed annular conductor elements 7 from the superconducting strip conductors 8 represented, however, the strip conductors 8 must be wound in a complex arrangement, and bonded thereafter in an electrically conductive manner by means of ohmic contacts which are fitted subsequently. As a result, the induced current flux in the conductor elements 7, according to the prior art, is not loss-free.

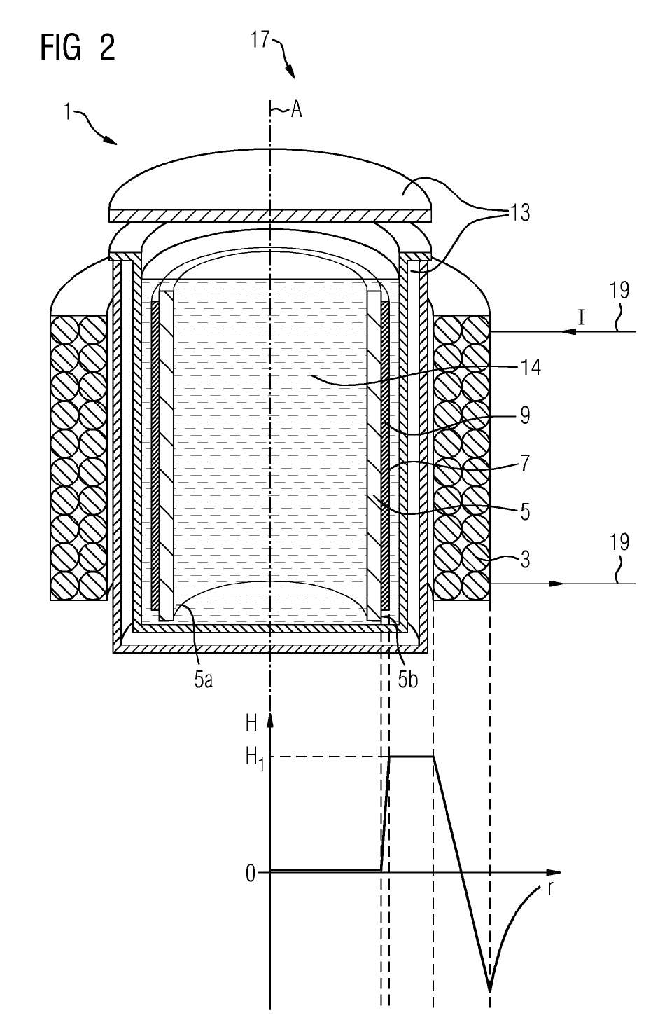

FIG. 2 shows an electric coil system 1 according to a first exemplary embodiment of the teachings of the present disclosure, in a similar schematic perspective representation. The coil system 1 comprises a choking coil 3 which, in turn, radially encloses the other components of the coil system 1 illustrated. On the interior thereof, a bath cryostat 13 is again arranged, which in this case, however, comprises a cylindrical bearing body 5, the outer side 5b of which is coated with a continuous superconducting layer 9.

A closed annular conductor element 7 is thus produced, formed of a uniform superconducting material. Element 7 does not require bonding by the subsequent application of ohmic contacts. In the first exemplary embodiment represented, there is a single closed annular conductor element, the axial dimension of which along the principal axis A is of similar magnitude to the axial dimension of the choking coil 3. The coil system 1 represented comprises an arrangement of circular cylindrical coils. The choking coil 3 and the annular conductor element 7 are aligned concentrically around a common system axis A. This alignment provides effective compensation of the magnetic field on the interior of the coil system and the reduction of transverse forces acting on the coils.

The characteristic of the magnetic field strength H as a function of the radius r is schematically represented in the lower part of the figure, in a similar manner to FIG. 1. Here again, substantial compensation of the magnetic field H in the interior of the coil system 1 is achieved by the shielding effect of the superconducting layer 9.

The bearing body shown in FIG. 2 is a circular cylindrical hollow body which, in principle, can be formed of either a non-conductive or an electrically-conductive material. Depending upon the shape of the outer choking coil 3, the bearing body can also assume other geometries including, for example, cylindrical shapes with non-circularly symmetrical base surfaces, or non-cylindrical geometric objects with shell-type surfaces. As the magnetic field H is already substantially compensated by the superconducting layer 9, the electromagnetic properties of the bearing body, in normal duty, are no longer relevant for the field characteristic in the further interior region.

The configuration of the bearing body 5 as a hollow body permits the economization of material, and also reduces the mass to be cooled. The superconducting layer 9 can, for example, be a magnesium diboride layer, which can be precipitated by means of aerosol deposition. Alternatively, however, other superconducting materials can be employed including, for example, other high-temperature superconductors of the REBCO type. Superconducting materials of this type can either be precipitated from the gaseous phase, or from a solution. In some embodiments, the superconducting layer 9 is configured as a continuous superconducting coating on a closed annular surface of the bearing body 5, such that no subsequently-applied and normally-conducting contact is required. Although the superconducting layer 9 can be configured with a uniform layer thickness, the thickness of the layer can also, in principle, be varied, in order to compensate, for example, inconsistencies in the magnetic field H in the axial direction.

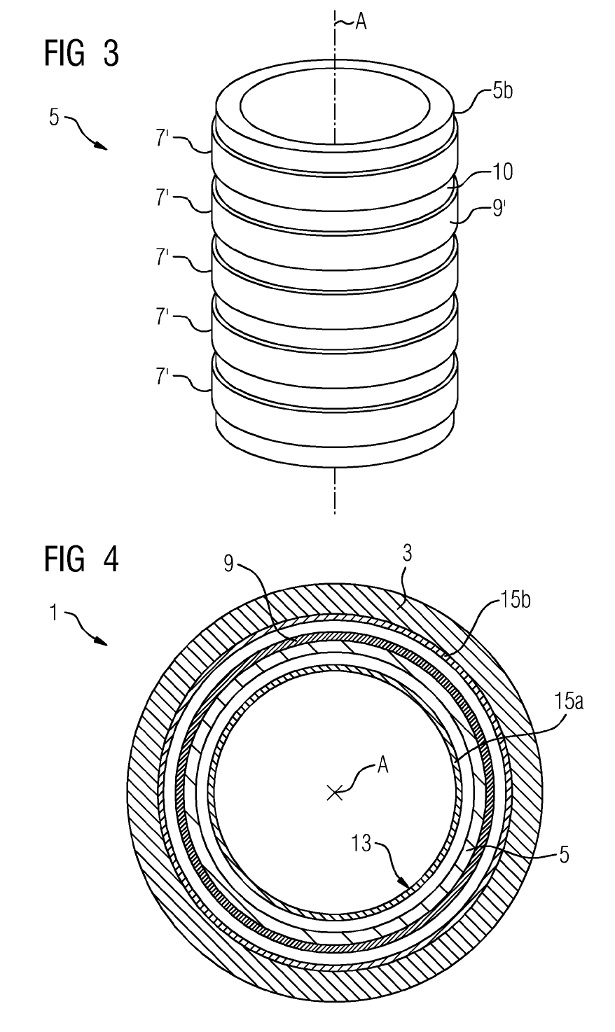

FIG. 3 shows an alternative bearing body 5, which can be employed in a coil system according to a second exemplary embodiment of the invention. The remaining components of the coil system, for example, can be arranged analogously to the representation shown in FIG. 2. The bearing body 5 shown in FIG. 3 is likewise a hollow cylindrical body, the outer shell surface of which is coated with a superconducting layer 9′. In contrast to the first exemplary embodiment, however, this superconducting layer 9′ is subdivided into a plurality of annular conductor elements 7′. A plurality of closed annular conductor elements in a parallel arrangement is thus provided, in each of which a closed ring current can flow, in a similar manner to the prior art represented in FIG. 1. By way of distinction thereto, however, the individual annular conductor elements 7′ are each configured here as a continuous superconducting layer 9′, with no requirement for the subsequent application of electrical contacts. The individual conductor elements 7′ can be applied simultaneously in a single coating procedure.

Herein, the structuring thereof can either be performed during the coating process, for example by means of shadow masks, or can be achieved after the application of the layer by the removal of material from the interspaces 10. The arrangement of the five parallel annular conductor elements 7′ shown here is to be understood as exemplary only herein, wherein a smaller or substantially larger number of conductor elements 7′ may be present. The axial dimension of the individual conductor elements 7′ can also be selected to be substantially greater here than in the prior art represented in FIG. 1, as the dimension of the individual rings is not restricted by the size of commercially-available superconducting strip conductors 8. The subdivision of the superconducting layer 9′ into individual part-rings, the presence of uncoated regions 10 between these rings, can prevent unwanted induced currents in the axial direction.

FIG. 4 shows a schematic cross section of an electric coil system 1 according to a further exemplary embodiment of the invention. Here again, a choking coil 3 is configured in a radially outer arrangement. In the interior region, a cryostat 13 is again arranged which, in the present example, is configured as a hollow cylindrical container having an inner cryostat wall 15a and an outer cryostat wall 15b. In turn, between the two cryostat walls 15a and 15b, a hollow cylindrical bearing body 5 is arranged which, here again, is coated on its outer side with a superconducting layer 9. This superconducting layer 9, in a similar manner to that shown in FIG. 2, can in turn be configured as a single closed annular cylindrical shell or, in a similar manner to that shown in FIG. 3, can be configured as a plurality of closed annular conductor elements running in a parallel manner.

In some embodiments, the interior of the cryostat can remain free of material, and is thus also free of coolant. The coil system 1 can thus be of a relatively material-saving design. Optionally, the region on the interior of the inner cryostat wall can additionally be available as a space for a plunger core which, for example in the event of a malfunction, can be inserted in the interior of the coil system 1 to increase inductance. Alternatively, a soft magnetic core can also be permanently located on the interior of the coil system 1.

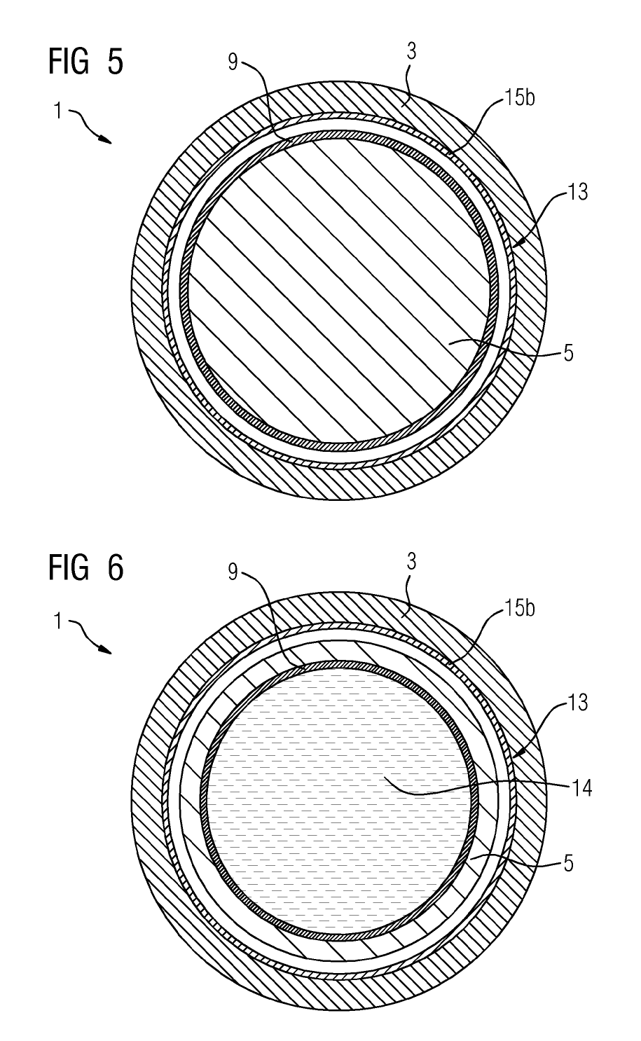

FIG. 5 shows a further schematic cross section of a coil system 1 according to a fourth exemplary embodiment of the invention. A choking coil 3 is again configured in a radially outer arrangement here. Here again, on the inner side, a cryostat 13 is arranged adjacently to the choking coil 3. Within the cryostat wall 15b, in this case, a solid cylindrical bearing body 5 is arranged, which is coated with a superconducting layer 9 on its outer side. Here again, said layer 9 can either be applied to the outer side of the bearing body as a single conductor element or as a plurality of conductor elements. The material of the solid cylinder can advantageously be a non-magnetic material such as, for example, a glass fiber-reinforced plastic or special steel. Alternatively, the bearing body can also be formed of a soft magnetic material, such that inductance is increased in the event of a malfunction. In normal duty, the core is electromagnetically shielded by the superconducting layer.

FIG. 6 shows an electric coil system 1 according to a further exemplary embodiment of the invention, in schematic cross section. Again, in this fifth exemplary embodiment, the coil system 1 has a radially outer choking coil 3, which is radially adjoined on its inner side by a cryostat wall 15b. On the interior of the cryostat 13, here again, a hollow cylindrical bearing body 5 is arranged, the inner shell surface of which, in the present example, is coated with a superconducting layer 9. In the interior of the bearing body 5 thus coated, a liquid coolant 14 flows or is accommodated, the function of which is the cooling of the superconducting layer. This coolant can be, for example, liquid nitrogen, helium or neon.

The bearing body 5 can thus simultaneously serve as a carrier for the superconducting layer, and as a receptacle for the coolant 14. Optionally, in the configuration represented in FIG. 6, the additional outer cryostat wall 15b can also be omitted, and the bearing body 5 can simultaneously function as the outer cryostat wall. The bearing body 5 shown in FIG. 6, the inner wall of which is coated with the superconducting material 9, may be comprised of a non-electrically-conductive material, as the magnetic field of the choking coil is only compensated in the interior thereof by the superconducting layer 9. In this case, a bearing body 5 of a conductive material would result in an unwanted and additional induced current in said bearing body 5, thereby resulting in unnecessary electromagnetic losses. By the selection of a non-electrically-conductive material for the bearing body 5, the magnetic field can nevertheless be compensated here by the superconducting layers 9 in a virtually loss-free manner. Further potential exemplary embodiments comprise coil systems having at least one superconducting layer arranged on a shell surface of a bearing body, on the interior of which a plurality of annular and short-circuited coil sections are arranged adjacently in the radial direction, for the purposes of shielding.

What is claimed is:

1. An electric coil system comprising:
a choking coil; and
a bearing body arranged inside the choking coil; and
at least one closed annular superconducting conductor element having at least one closed annular superconducting layer arranged on the bearing body.

2. The electric coil system as claimed in claim 1, wherein the choking coil and the bearing body share a common central axis.

3. The electric coil system as claimed in claim 1, wherein the bearing body comprises a cylindrical surface upon which the at least one closed annular superconducting layer is arranged.

4. The electric coil system as claimed in claim 1, wherein the bearing body comprises a hollow body.

5. The electric coil system as claimed in claim 4, wherein the at least one closed annular superconducting layer is arranged on an inner surface of the hollow body.

6. The electric coil system as claimed in claim 1, wherein the bearing body comprises a solid body.

7. The electric coil system as claimed in claim 1, wherein the at least one closed annular superconducting layer is arranged on an outer surface of the bearing body.

8. The electric coil system as claimed in claim 1, wherein the at least one closed annular superconducting layer comprises a high-temperature superconducting material.

9. The electric coil system as claimed in claim 1, wherein a plurality of closed annular superconducting conductor elements run in a mutually parallel manner, and each element of the plurality comprises at least one closed annular superconducting layer.

10. The electric coil system as claimed in claim 1, further comprising a cryostat.

11. The electric coil system as claimed in claim 10, wherein the at least one closed annular superconducting layer is arranged on a wall of the cryostat.

12. An inductive-resistive current limitation system comprising:
a choking coil;
a bearing body arranged inside the choking coil; and
at least one closed annular superconducting conductor element having at least one closed annular superconducting layer arranged on the bearing body.

13. A method for producing an electric coil system including—a choking coil, a bearing body arranged inside the choking coil, and at least one closed annular superconducting conductor element having at least one closed annular superconducting layer arranged on the bearing body, the method comprising:
precipitating a closed annular superconducting layer on a surface of the bearing body.

14. The method as claimed in claim 13, wherein the closed annular superconducting layer is precipitated by aerosol deposition.

15. The method as claimed in claim 13, wherein the closed annular superconducting layer is precipitated from a solution.
